(19) United States
(12) Patent Application Publication
(10) Pub. No.: US 2006/0281477 A1
(43) Pub. Date: Dec. 14, 2006

(54) Dynamic detection and configuration of networked audio/video components

(75) Inventor: Patrick G. Downes, Escondido, CA (US)

Correspondence Address: THELEN REID & PRIEST, LLP, P. O. BOX 640640, SAN JOSE, CA, 95164-0640, US

(73) Assignee: Radial Labs, Inc., a Delaware Corporation

(21) Appl. No.: 11/450,780

(22) Filed: Jun. 8, 2006

Related U.S. Application Data
(60) Provisional application No. 60/688,810, filed on Jun. 8, 2005.

(51) Int. Cl. H04Q 7/20

(52) U.S. Cl. 455/509; 455/556.1; 455/41.2

(57) ABSTRACT

One or more controllers use a first highly directional wireless communication system (first WCS) to communicate with one or more renderers to select one or more of the renderers for rendering content; The controller also communicates with one or more content servers over a convenient link to set up communications between the content server and the renderer. Finally, the content sever communicates with the renderer over a second wireless communications system (second WCS) as directed by the controller to download a content stream from the content server to the selected renderer(s) for rendering. Many devices comprising any or all of the controller, renderer and content server may interact in this way.

### FIELD OF THE INVENTION

The present invention relates to dynamic detection and configuration of networked audio/visual (A/V) components. Such A/V components may include, without limitation, renderers such as loudspeakers and the like for audio rendering and visual displays, monitors and the like for visual rendering, controllers for controlling the operation of the system and the flow of content, and content servers for serving stored audio and/or visual content for playback.

### BACKGROUND OF THE INVENTION

Wireless Connections

A/V components are often sold as systems of components such as amplifiers, compact disc (CD)/digital versatile disk (DVD) player-recorders, loudspeakers, video monitors, media center computers, and the like. Traditional audio playback chains maintain wired connections along the length of the chain, beginning with the source of the music (e.g., turntable, cassette deck, CD player, and the like) and ending at the loudspeakers. Recently some of the wired connections have been replaced by wireless communication links. These links include radio frequency (RF) such as those conforming to the IEEE 802.11 standards (The Institute of Electrical and Electronics Engineers, Inc. Standard Std 802.11-1999 Edition (Reaffirmed 12 Jun. 2003) and entitled “IEEE Standard for Information technology—Telecommunications and information exchange between systems—Local and metropolitan area networks—Specific requirements: Part 11: Wireless LAN Medium Access Control (MAC) and Physical Layer (PHY) Specifications” (including IEEE Std. 802.11a-1999 (R2003), IEEE Std. 802.11b-1999 (R2003), IEEE Std. 802.11b-1999/Cor 1-2001, IEEE Std. 802.11g-2003 and IEEE Std. 802.11d-2001 (collectively referred to herein as the “IEEE 802.11 standard” or “802.11”).

While such wireless links can simplify the physical arrangement of components, obviate complex wiring and enhance mobility of components, the wireless links can complicate system configuration because a physical connection/association/context is not provided by the (now missing) wires, and components must thus be associated through user interfaces, wireless protocols and software/firmware of the components.

Wireless Discovery

When using wireless communications to communicate information between a first device and a second device, a link must first be established between the communicating devices. The first device must “Discover” other devices/networks with which to communicate. Then it may carry out authentication, association and network parameter configuration processes to establish the communication link or connection with the second device.

Once a communication link is established between a first device and a second device, a second discovery process is typically carried out to discover the services available over the communications link. Finally, one or more of the available services may be invoked.

Known discovery mechanisms for wireless devices and services available thereon include standards such as uPnP (universal plug and play protocol), Zeroconf (an Internet Engineering Task Force (IETF) standard), Bonjour (Apple Computer's Zeroconf solution) and Bluetooth (SDP). Such standards use the wireless communications capability to probe for and to announce the availability of devices and services. These schemes work well for many scenarios, and are widely adopted as standards (e.g., DLNA (Digital Livingroom Network Alliance) has standardized on uPnP as a discovery and control protocol).

What is needed is an improved protocol, method and apparatus for easily coordinating and selecting components for use.

### BRIEF DESCRIPTION

In a first aspect of the invention one or more portable controllers use a first highly directional wireless communication system (first WCS) to communicate with one or more renderers to select one or more of them for rendering content. The controller also communicates with a content server over a convenient link to set up communications between the content server and the renderer. Finally, the content sever communicates with the renderer over a second wireless communications system (second WCS) as directed by the controller to download a content stream from the content server to the selected renderer(s). Many devices comprising any or all of the controller, renderer and content server may interact in this way.

Connecting to Specific Networked Devices

The coverage volume for the physical layer of a radio frequency (RF)-based wireless communication system typically extends through walls, sometimes going well beyond a user's room and building and even into distant buildings. With typical wireless communication maximum ranges in the 10s to 100s of meters, many devices which might not be desired can be discoverable, including those in other rooms, offices and apartments, leading to unnecessary ambiguity that ultimately must be resolved by the user. For example there might be a dozen or more different rendering devices such as wireless speakers in a house, on the same subnet and all visible through traditional discovery mechanisms. Even though a user might be sitting in front of just one pair of those speakers in a room, he still must select that pair from a list of speakers presented by the traditional discovery mechanism. This is not particularly easy to do and introduces an unnecessary level of complexity, which is a barrier to adoption and use.

One solution to the problem of selecting a local rendering device is to bypass traditional wireless discovery protocols and use a mechanism which allows the user to select the rendering device by simply pointing to, touching or otherwise gesturing at the local rendering device. In accordance with this approach a first highly directional wireless communication system whose coverage volume is local to the acoustic or visual field of the audio or visual renderers. This first WCS can be implemented using IR (Infra Red), visible light, acoustic or magnetic fields as the information carrier, using any suitable modulation technique. In an example, conventional consumer electronics IR systems typically used for television remote controls and the like may be used and have the advantages of long range within a room, security due to line-of-sight, and low cost. Alternatively, the first WCS could be implemented by requiring physical contact between two devices using conductive pads, utilizing very short range electromagnetic communication, or the like.

The first WCS may be used in at least these two contexts where the controller is attached to either the renderer or the server: when sending, by pointing a content server at a renderer (e.g., pointing a wireless portable music player at a wireless speaker), and when receiving, by pointing a renderer at a server (e.g., pointing portable wireless headset at a companion's portable music player) in order to share the music.

In the first context, when sending, the user points the content server at and sends a Configuration Message (CM) to the renderer using the first WCS. This CM contains the information necessary for the renderer to start receiving the content stream from the content server over the second WCS. The information in the CM may include network parameters such as channel identification, security parameters, sender information, and the like.

In the second context, the renderer is pointed at the content server, and via the first WCS either passively receives a Configuration Message (if it is periodically transmitted on the first WCS simultaneously with the content streaming on the second WCS, and this renderer is joining a multicast transmission) or it sends a request message to the content server asking for the content server to send the renderer a Configuration Message.

Upon receipt of the Configuration Message by the renderer, it has the information it needs to configure itself to receive the content stream from the content server on the second wCs.

Security Configuration and Authentication

The first WCS can be used to transmit security configuration information for the second WCS link (e.g., WEP (wireless encryption protocol) keys and the like) from device to device in a relatively secure manner. An eavesdropper would have to be within the limited field of the first WCS, rather than being able to eavesdrop on the larger coverage volume of the second WCS.

The limited local field of the first WCS also provides a physical authentication envelope that would normally preclude a third party from streaming to or from a user's devices. This would, for example, prevent an occupant of a neighboring apartment from streaming a neighbor's music into his speakers.

Simple Device Control

The first WCS could be used exclusively in a very inexpensive device for simple control operations, such as volume control or channel select.

A Simple User Interface for Discovery and Configuration: Single Switch

Given the first WCS solution above, a simple user interface (UI) for handheld controller may include a single “Select” switch attached to the handheld controller so that it is easy and natural to operate when pointing the handheld controller at a device to be controlled.

For devices that have both the capability to send and receive, an enhanced UI could have a two-pole switch (implemented in any number of ways from an actual switch to a touch sensitive pad, and the like) where operating it one way means a user wants to receive a stream from the other device, and where operating it the other way means the user wants to send a stream to the other device. Such a switch could be constructed so that as the user points the device at another, he would push the switch towards the other device to send, and pull the switch to receive.

Bypassing Network Discovery and Association prior to Device Discovery

A problem that exists when using IEEE 802.11 networks is that before devices can be discovered using standard protocols such as uPnP and Zeroconf, the probing device must first discover and associate with the network. This can be time consuming and difficult, especially if the network uses encryption such as wireless encryption protocol (WEP). For each network that is visible, this network association and configuration must occur before any suitable devices can be discovered. This can be a tremendous burden on the user, requiring manual intervention and potentially many dead-end paths when associating with networks that don't have any suitable devices for connection.

To solve this problem special information is added to network packets that is available prior to association in order to allow a device to find desired devices prior to network authentication and association. This information can be added as Information Elements which are part of IEEE 802.11 Beacon, Probe Request and Probe Response packets. This information can be encoded into existing Information Elements such as the SSID, or new Information Elements can be created.

Identifying Networked Components with Pictures

Sometimes the device a user wants to connect with is not local, and pointing at it is not an option. For instance one might be interested in sending audio to wireless speakers that are out on a remote deck of the house; or one might be interested in receiving music from a server that is in another room. For this, a Graphic User Interface is used where each device must be uniquely identified in a list. This involves a configuration step when adding a device to a network. Such an identifier should portray the physical context of the device. For example, a useful text description might be “Kitchen Speakers”; but to create the text string, some sort of text input device must be provided which can be cumbersome to integrate into and use in small devices. A solution to this identification step is to use a graphical representation such as photograph, icon or other symbol or symbols representative of the device, its physical context or the device in its physical context.

Using a Remote Controller to Discover Devices

A remote controller can be used to discover and connect servers and renderers. The server might be local and discovered using the First WCS, or it may be remote and discovered as described above or it may be discovered by other means. The renderer might be local and discovered using the First WCS, or it may be remote and discovered as described above or it may be discovered by other means.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a system block diagram of a networked media system in accordance with an embodiment of the present invention illustrating three fundamental logical components that are used in such networked media systems: content servers, renderers and controllers.

FIG. 2 is a diagram illustrating a renderer for audio output in accordance with the present invention which is also referred to herein as a wireless speaker system (WSS).

FIG. 3 is a diagram illustrating a system in accordance with the present invention, the system having a controller and a server integrated into one portable enclosure to form a self-contained wireless portable music player (WPMP).

FIG. 4 is a diagram illustrating a system in accordance with the present invention like that of FIG. 3 but wherein the system comprises a non-wireless portable music player and a “sleeve” device which has user controls and indicators and attaches and informationally couples to the portable music player.

FIG. 5 is a diagram illustrating a system in accordance with an embodiment of the present invention where a controller and WSS are integrated into one portable enclosure forming a self-contained wireless portable speaker system (WPSS).

FIG. 6 is a system block diagram illustrating a configuration of components in accordance with an embodiment of the present invention, the configuration including a WPMP (602) which may be held and operated by a user who wants to render the music stored on the WPMP on the WSS (604). Also shown are additional speakers 606, 608 and 610 which are within the range of a Primary Communication Channel (PCC) used for communication between the devices, but which the user does not want to use for the music.

FIG. 7 is a process flow diagram illustrating a process in which a user of a portable device selects one or more renderers for wireless playback of content stored on the portable device.

FIG. 8 is a diagram illustrating the content requirements for a configuration message used in conjunction with the process of FIG. 7. This configuration message contains the information required by the renderer to receive the content over the PCC.

FIG. 9 is a process flow diagram illustrating a process in accordance with the present invention in which the user of a portable device selects one or more renderers for wireless playback of content stored either on the portable device or elsewhere.

FIG. 10 is a diagram illustrating a configuration of components in accordance with an embodiment of the present invention, the configuration including a WPSS (10A) which is held and operated by a user who wants to render the music on a WPSS from a remote Server (10B). Also shown are other servers (10C and 10D) which are within the range of the PCC, but with which the user does not want to connect.

FIG. 11 is a process flow diagram in accordance with an embodiment of the present invention illustrating a process in which a user may point a device to select a server for playback of content.

FIG. 12 shows several people congregating, each having a WPMP used with headphones for audio output. In accordance with an embodiment of the present invention any of the listeners may choose to listen communally to the music selected on any of the WPMPs in the group.

FIG. 13 is a system diagram in accordance with an embodiment of the present invention illustrating a configuration of components in accordance with an embodiment of the present invention. In this illustration a WPSS (13-A) is held and operated by a user who wants to control a remote Server (13-B) and cause it to send content over the PCC to render on WPSS(13-A). Also shown are other servers (13-C and 13-D) which are within the range of the PCC, but which the user does not want to use as a content source.

FIG. 14 is a process flow diagram illustrating a process in accordance with an embodiment of the present invention in which a user interacts with a content server to obtain playback of content.

FIG. 15 is a process flow diagram illustrating a process 1500 in accordance with an embodiment of the present invention in which a user interacts with a network using beacon, probe request and probe response packets, such as those available under the IEEE 802.11 standard, to discover and connect to remote speakers.

FIG. 16 is a process flow diagram illustrating a process 1600 in accordance with an embodiment of the present invention in which a user interacts with a network using beacon, probe request and probe response packets, such as those available under the IEEE 802.11 standard, to discover and connect to remote servers.

### DETAILED DESCRIPTION

Embodiments of the present invention are described herein in the context of a system of audio/video components implementing a method for dynamic detection and configuration of the audio/video components. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Eraseable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

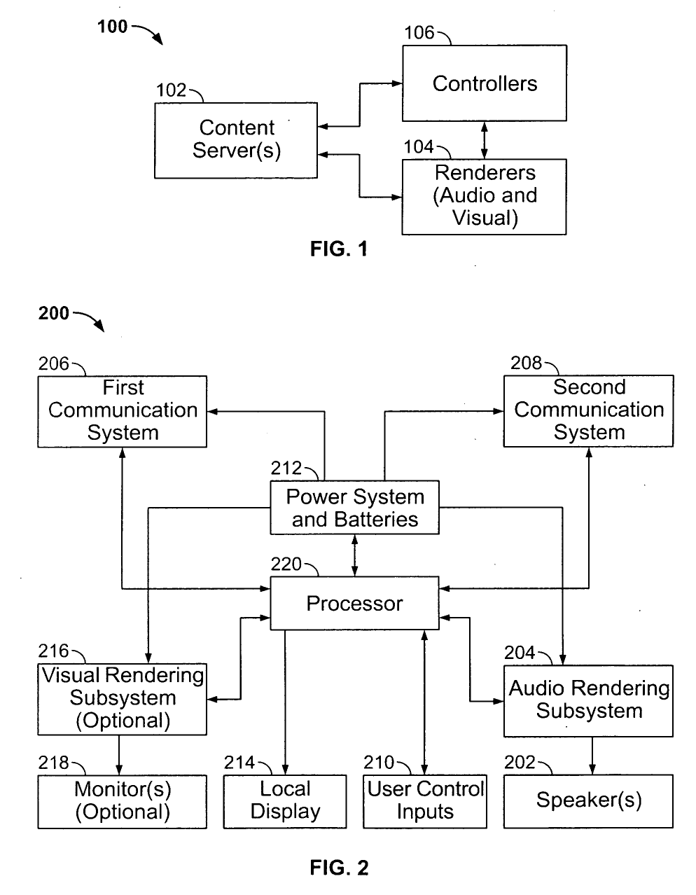

FIG. 1 is a system block diagram of a networked media system 100 in accordance with an embodiment of the present invention illustrating three fundamental logical components that are used in such networked media systems: content servers 102, renderers 104 and controllers 106.

Content Servers 102 are the repository for audio, video, text and other media, and can transmit the content over an external connection to other devices. Examples of Content Servers 102 include Personal Computers, Networked Storage Units, portable music players, and internet servers. The content might be stored on the server in an analog fashion, for example on analog tape; or it may be stored as digital data in a digital storage medium such as flash memory, CD, DVD and hard disk.

Renderers 104 are the output devices that convert the media files and streams into sound, light, motion, and/or other displays perceptible by humans. Examples of Renderers include audio speakers and video displays.

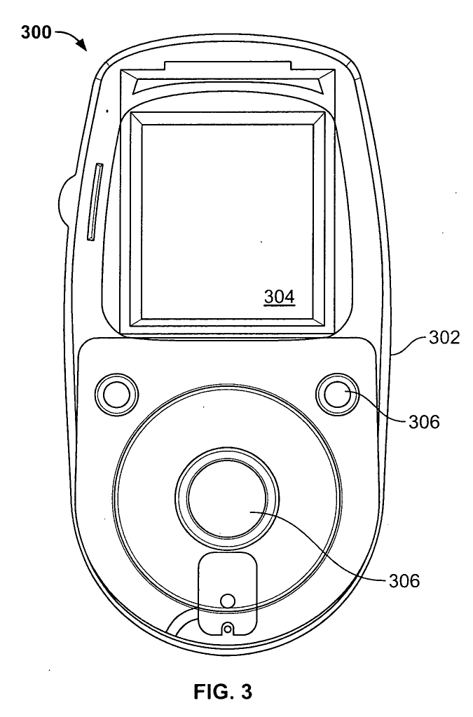

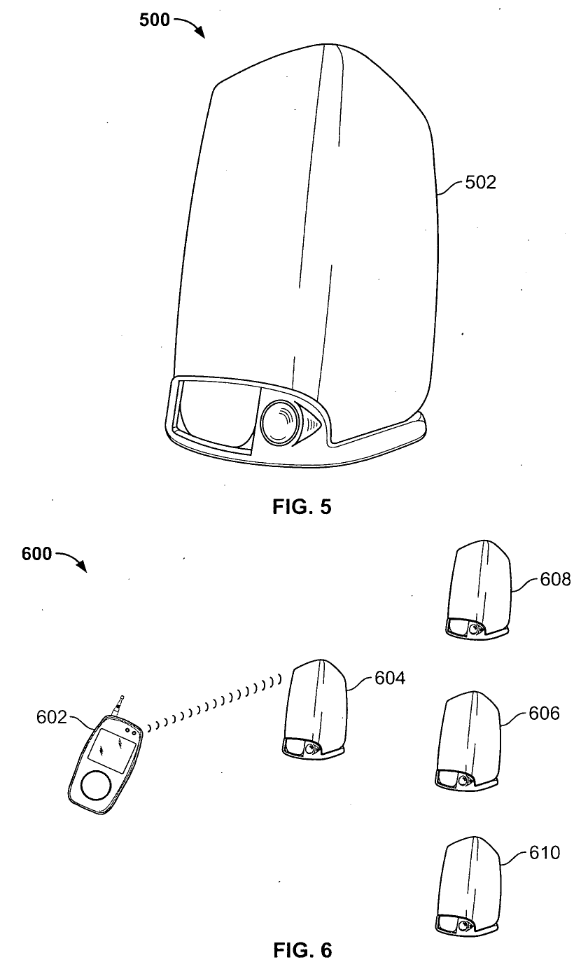

FIG. 2 is a diagram illustrating a renderer 200 for audio and optional visual output in accordance with the present invention which is also referred to herein as a wireless speaker system (WSS). The WSS includes a housing (FIG. 5: 502), one or more speaker drivers 202, an audio rendering subsystem 204 (including an audio amplifier such as a class-D digital audio amplifier), an infrared (IR) transceiver (first WCS) 206, an RF wireless transceiver (second WCS) 208, and user control inputs 210 such as a volume control. The system may be configured to include one or more speakers, such as a stereo pair, or two satellite speakers and a subwoofer speaker. A power system 212 provides power to the various components and optionally maintains a charge on batteries for portable operation. A local display 214 may be provided for local information display such as status information. An optional visual rendering subsystem 216 and optional visual display monitor 218 are provided if a visual program display is to be included. A processor 220 controls and communicates with the various systems and subsystems in a conventional manner.

Controllers 106 (FIG. 1) are the devices with which users interact to command Content Servers 102 to serve media and command Renderers 104 to render media. Examples are TV remote controls, PC applications, user interface (UI) subsystems of portable music players, and dedicated devices as described below.

Various products may be produced which include one or more of these fundamental components 102, 104 and 106 as included subsystems, depending upon the desired functionality of the product.

FIG. 3 is a diagram illustrating a system 300 in accordance with the present invention, the system having a controller and a content server integrated into one portable enclosure or housing 302 to form a self-contained wireless portable music player (WPMP). The system 300 illustrated in FIG. 3 includes an enclosure or housing 302 which is shaped to be handheld, a storage device (Flash or Hard Disk), circuitry that includes a processor and memory, a RF wireless transceiver and antenna which functions as the second WCS (also referred to herein known as the Primary Communication Channel (PCC)), an Infrared transceiver (first WCS), a microphone (optional); a headphone amplifier, a lithium-ion battery and related charging circuitry, a visual display 304 such as an LCD (liquid crystal display), optional LEDs (light emitting diodes) for reporting status, and user controls 306 including switches, rotary encoders, touch sensitive inputs, and the like.

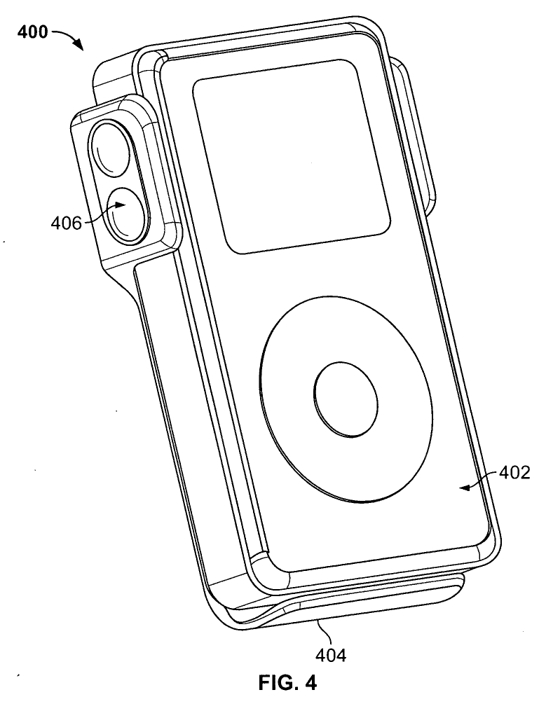

FIG. 4 is a diagram illustrating a system 400 in accordance with the present invention like that of FIG. 3 but wherein the system comprises a non-wireless portable music player 402 and a “sleeve” device 404 which has user controls 406 and indicators (not shown) and attaches and informationally couples to the portable music player 402.

FIG. 5 is a diagram illustrating a system 500 in accordance with an embodiment of the present invention where a controller and WSS are integrated into one portable enclosure 502 forming a self-contained wireless portable speaker system (WPSS).

The media flows or “streams” from a Content Server 102 to one or more Renderers 104 over one or more PCC s. The physical medium of the channel might be a guided medium such as a wire or fiber optic cable, or an unguided medium such as radio or infrared. When transmitted from a Content Server 102 to a Renderer 104, the media is converted into signals suitable for the communication medium. For example, digital data is converted into an analog signal for transmission over a wire, or across an FM (frequency modulated) radio channel, and the like. Another example is that stored analog information is converted to digital data for transmission over a wireless digital data communication channel such as provided by IEEE 802.11, Bluetooth, UWB, IR, magnetic induction, and the like.

When the media is transmitted over a PCC which is a digital data communication channel, protocol layers above the physical layer (e.g., link layer, network layer, transport layer, application layer) define how the data is packaged and communicated, and how errors are detected and corrected (as is well known in the art).

The PCC can be point-to-point or broadcast. In some broadcast communication implementations such as FM radio and network UDP/IP, neither the transmitter nor the receiver(s) maintain state, and the transmitter simply sends the media, and the receiver receives it, and errors are not corrected. In digital network communications, UDP/IP streams are often used for multicast, which is a system/method of having multiple simultaneous receivers for one transmitted stream. The advantage of multicast vs. reliable unicast (TCP/IP) is that, in the absence of errors, the bandwidth required for transmission to one receiver is the same as the bandwidth required for many receivers, whereas in unicast, the bandwidth required for n receivers is n times the bandwidth required for one receiver. Even though errors are not detected or corrected in the transport or network layer using UDP/IP, errors can be detected and requests can be made for retransmission of missing packets at the application level resulting in a reliable bandwidth efficient multicast transmission.

Scenario 1—Roaming Server

FIG. 6 is a system block diagram illustrating a configuration 600 of components in accordance with an embodiment of the present invention, the configuration including a WPMP (602) which may be held and operated by a user who wants to render the music stored on the WPMP 602 on the WSS (604). Also shown are additional speakers 606, 608 and 610 which are within the range of a Primary Communication Channel (PCC) used for communication between the devices, but which the user does not want to use for the music.

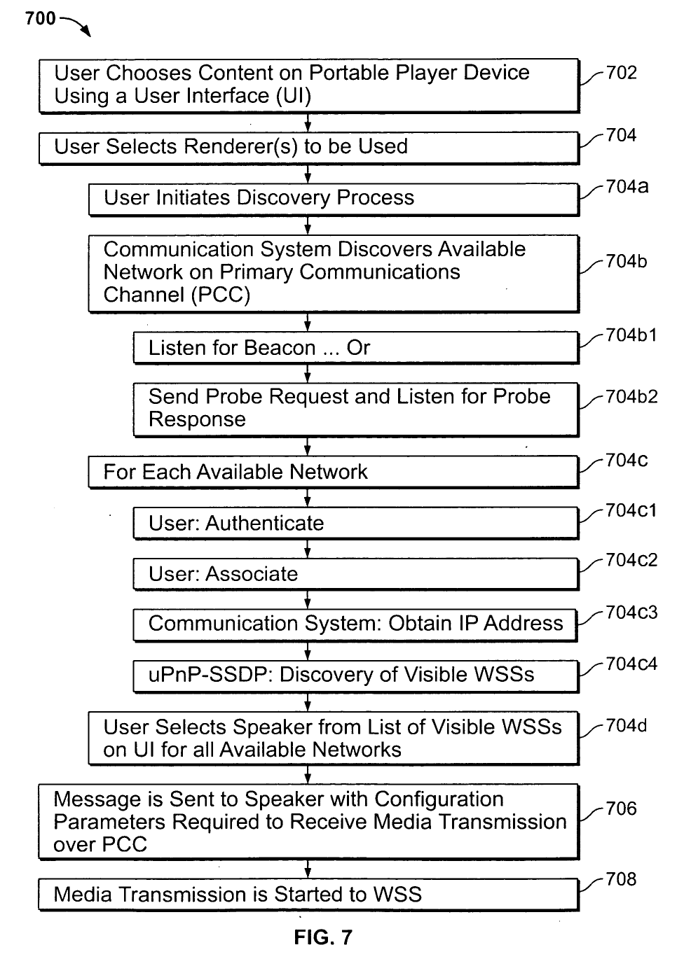

FIG. 7 is a process flow diagram illustrating a process 700 in which a user of a portable device selects one or more renderers for wireless playback of content stored on the portable device. The first step 702 is to select a particular content item such as a song or list of songs to be rendered by the renderer. The next step 704 is to select the renderer or renderers to be used. This step may include a number of substeps and may include selecting speakers to render the audio or music, which may, in one embodiment, be done by having the user initiate a discovery process (704a) to first discover all 802.11 networks (or other wireless networks to be used) that are visible on all 802.11 channels (704b). This can be done by listening for a beacon (704b1) or sending and receiving a response to a probe request (704b2). Then for each available network (704c) the user must authenticate (704c1) and associate (704c2) with each of those networks before using them to discover speakers (7-4-b). This association might involve user interaction to provide a security key (e.g., a wireless encryption protocol (WEP) key) for the network, and might further involve modifying that 802.11 network's access point to include the user's device's MAC address in an authorized devices list (704c3). Once associated with each network, the communication system must use a standard discovery protocol such as uPnP or Zeroconfto discover available WSSs (704c4). This example uses uPnP's SSDP (704c4). Finally, a list of available WSSs can be presented on the user interface display and the user can select the desired speaker from that list (704d). A configuration message (CM) is then sent to the selected speaker (706). Finally content transmission is started to the selected WSS (708). Note that while an audio program is described herein as the content to be provided or played, other content streams may also be played such as content streams including pictures or video, and the like. In such situations adequate bandwidth should be provided in the PCC to carry the additional content and a monitor or monitors will also be selected to display the visual content portion.

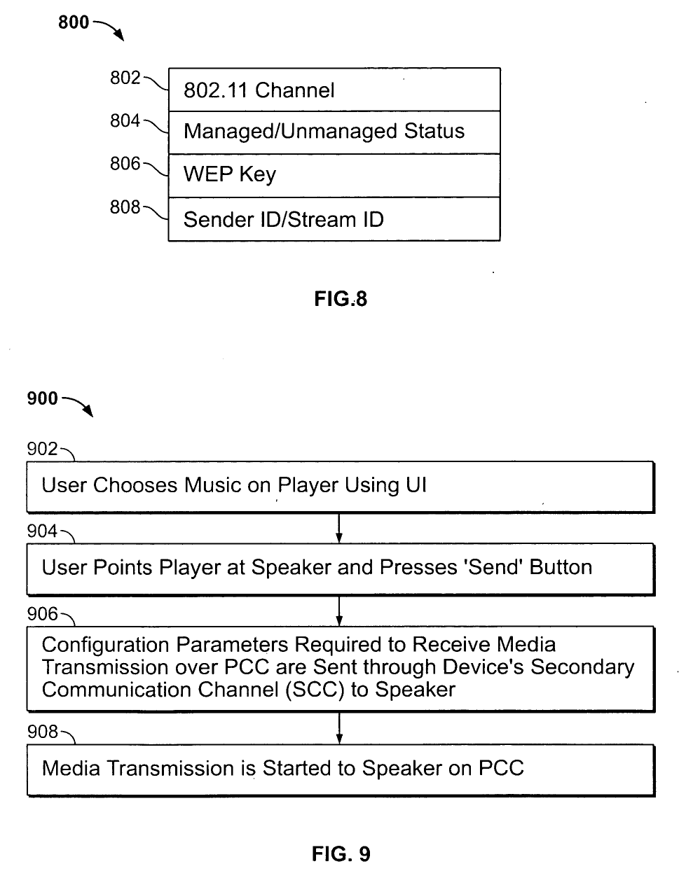

FIG. 8 is a diagram illustrating the content requirements 800 for a configuration message used in conjunction with the process of FIG. 7 in accordance with one embodiment of the invention. This configuration message contains the information required by the renderer to receive the content over the PCC. This includes the 802.11 channel to be used (802), managed/unmanaged status (804), a WEP (wireless encryption protocol) key (806), and sender identification and stream identification information (808). The speaker then configures itself to receive the stream and waits for the transmission to begin. The player then starts transmission of the media over the PCC.

FIG. 9 is a process flow diagram illustrating a process 900 in accordance with the present invention in which the user of a portable device selects content for rendering (902) and then selects one or more renderers for wireless playback of content stored either on the portable device or elsewhere (904-908).

A Secondary Communication Channel (SCC) (first WCS) is used to unambiguously select the particular speaker the user wishes to use as a renderer (904), independent of the typical discovery procedures use with the PCC. The SCC used here is an Infrared link, where the transmitting device uses an IR LED whose intensity is modulated with the information to be transmitted, and where the receiver contains an IR detector that demodulates the information. The directivity patterns of the transmitting LED and the receiving IR detector are such that the user can unambiguously point the transmitter at the receiver without simultaneously transmitting to undesired speaker. No other user interaction is required for the discovery and selection process besides the natural and intuitive ‘Point and Listen’ action.

Even though the SCC shown here is IR, which has the advantages of long range within a room, security due to line-of-sight, and inexpensive to implement, other types of communications channels can be used, including any channel whose coverage volume is local to the acoustic or visual field of the audio or video renderers. Other examples include visible light, acoustic or magnetic fields as the information carrier, using any suitable modulation technique. Alternately, the secondary channel could require physical contact between two devices using conductive pads, mating connectors, or very short range electromagnetic communication.

The local field nature of the SCC provides a level of security that is lacking in omni-directional, wall penetrating RF communication channels. Thus the SCC can be used to transmit security configuration information for the primary link (e.g., WEP key) from device to device in a relatively secure manner as part of the CM. An eavesdropper would have to be within the limited field of the secondary communication channel, rather than being able to eavesdrop on the larger coverage volume of the primary channel.

The limited local field of the secondary channel also provides a physical authentication envelope that would preclude a third party from streaming to or from a user's devices. This for example would prevent an occupant of a neighboring apartment from streaming music into your speakers.

After pointing the Player at the desired renderer (904), the user presses a button which causes a transmission of a CM to the selected speaker over the SCC (906). The Player then starts transmission of the media over the PCC (908).

The media transmission started in (908) can be either a unicast or multicast. If it is a unicast transmission and the user wants to simultaneously render the music on speakers other than those initially selected, they can repeat steps 904, 906 and 908 for additional speakers, causing additional unicast transmissions to be started. If the media transmission started in (908) is multicast or reliable multicast and the user want to simultaneously render the music on speakers other than those selected, they can repeat steps 904 to 906 for additional speakers, causing no additional transmissions to be started; in this case the additional speakers join in on receiving the original multicast transmission. The speakers will continue to render the media transmitted on the PCC until either the transmission fails, the transmission stops because the media transmission is complete or is ended by the transmitting user, or if a user sends a command over either the PCC or the SCC or operates a control on the speaker commanding it to stop. At that point the speaker will reset to a state where it waits for a new CM.

Scenario 2—Roaming Renderer Tuning into an Existing Transmission

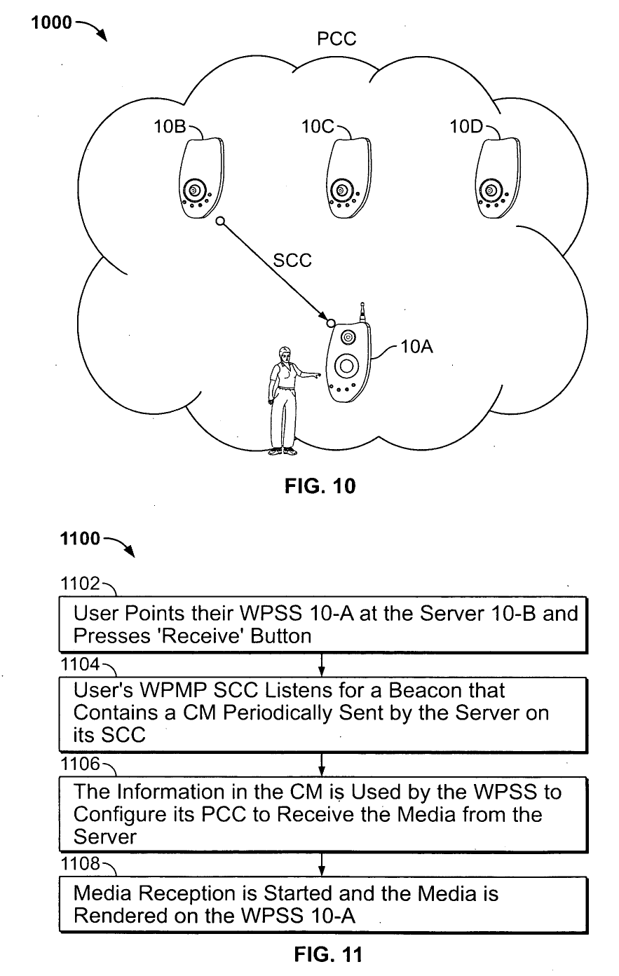

FIG. 10 shows a WPSS (10A) which is held and operated by a user who wants to render the music on his WPSS from a remote Content Server (10B) which may already be broadcasting music. Also shown are other content servers (10C and 10D) which are within the range of the PCC. For example, the content server 10B might be a WPMP such as 602 (FIG. 6), and the WPSS user wants to listen to the same music as the user of the WPMP who could be listening with headphones. As another example, the server might be coupled to a Satellite radio receiver that continually streams music. The PCC in this example is 802.11.

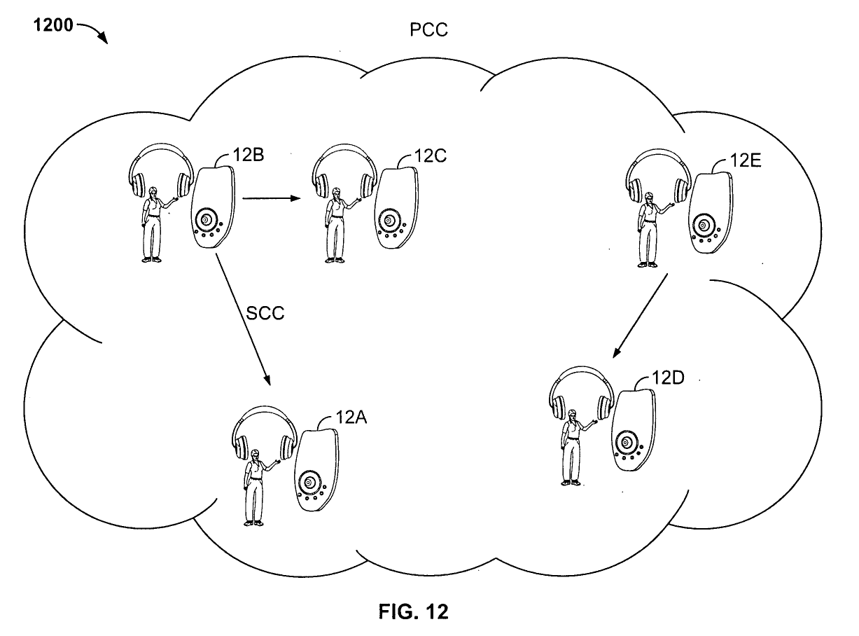

FIG. 11 is a process flow diagram in accordance with an embodiment of the present invention illustrating a process 1100 in which a user may point a device to select a renderer for playback of content.

In this example, the WPSS 10A is pointed at the content server 10B (1102), and the SCC passively receives the CM (1104) which is periodically transmitted by the content server which gives it the configuration information needed (1106) to join a multicast from the content server 10B (1108). Alternatively, the WPSS 10A could send a message requesting a CM to the Server over the SCC to receive the CM.

FIG. 12 is a diagram showing a roaming renderer configuration 1200 with several people congregating, each having a WPMP (12A, 12B, 12C, 12D, 12E) used with headphones for audio output. In accordance with an embodiment of the present invention any or all of the listeners may choose to listen communally to the music selected on any of the WPMPs in the group. Prior to this invention, each would each be listening to different songs each would have to select on their own WPMPs. With this invention each listener could choose to listen communally to the music selected on any of the groups' WPMPs.

Scenario 3—Roaming Renderer Controlling a Remote Server

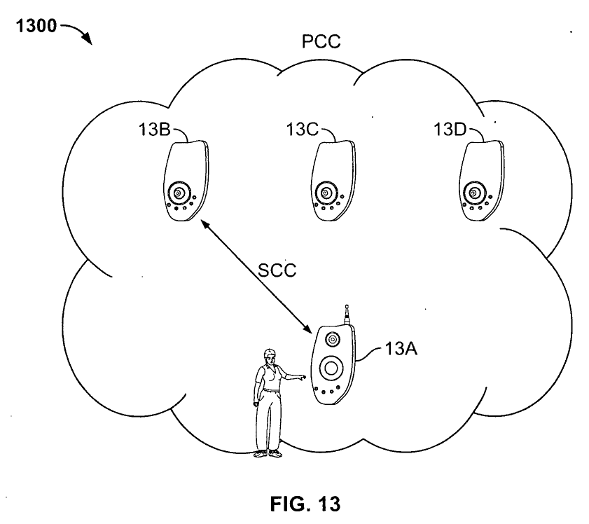

FIG. 13 is a system diagram in accordance with an embodiment of the present invention illustrating a configuration of components 1300 in accordance with an embodiment of the present invention. In this illustration a WPSS (13A) is held and operated by a user who wants to control a remote content server (13B) and cause it to send content over the PCC to render on WPSS (13A). Also shown are other content servers (13C and 13D) which are within the range of the PCC (IEEE 802.11), but which the user does not want to use as a content source.

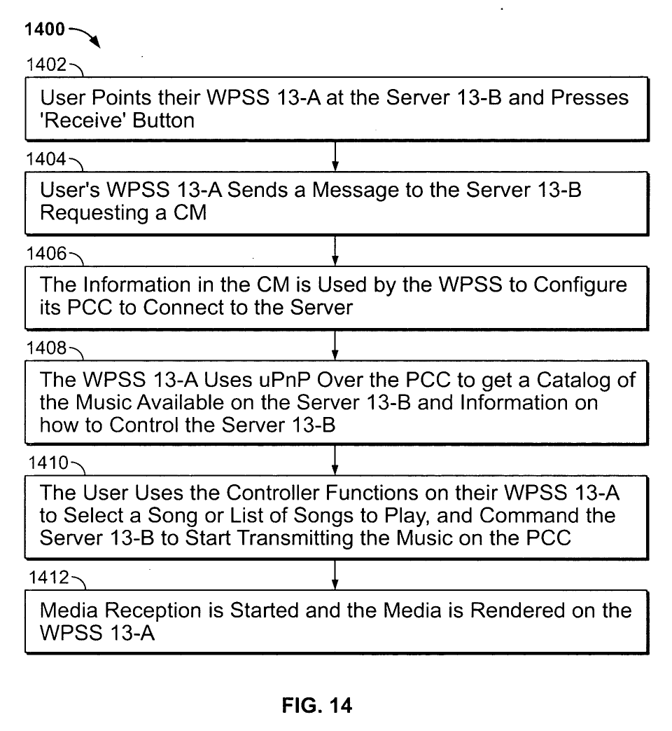

FIG. 14 is a process flow diagram illustrating a process 1400 in accordance with an embodiment of the present invention in which a user interacts with a content server to obtain playback of content.

FIG. 14 shows a flow diagram of the steps needed to achieve the user's wishes using a preferred method. In step 1402 a user points his WPSS 13A at a content server and presses a “receive” button or control. At 1404 the user's WPSS SCC sends a message to the content server 13B requesting a CM. At 1406 the information in the CM is used by the WPSS to configure its PCC to connect to the content server for receipt of a content stream. At 1408 the WPSS 13A uses uPnP (universal plug and play protocol) or an equivalent protocol over the PCC to obtain a catalog of the music (or content) available on the content server 13B and information on how to control the content server 13B. At 1410 the user uses the controller functions on his local WPSS 13A to select a song or list of songs (or other content) to render, and commands the server 13B to start transmitting the content on the PCC. At 1412 content reception is started and the content is rendered on the WPSS 13A.

Bypassing Network Discovery and Association prior to Device Discovery for Non-Local Devices

Sometimes the device to be connected to is not local, and pointing at it is not an option. For instance one might be interested in sending audio to wireless speakers that are out on a remote deck in the house; or one might be interested in receiving music from a server that is in another room. In the case of sending audio to remote speakers, the flow diagram of FIG. 7 becomes the default method of discovering and connection to the peripheral device. A similar discovery process would be used by default for finding remote wireless servers.

An issue with the method shown in FIG. 7 is that before devices can be discovered using standard protocols such as uPnP and Zeroconf the probing device must first discover and associate with the network. This can be time consuming and difficult, especially if the network uses encryption such as 802.11 WEP (Wireless Encryption Protocol). For each network that is visible, this network association and configuration must occur before any suitable devices can be discovered. This can be a tremendous burden on the user, requiring manual intervention and potentially many dead-end paths when associating with networks that don't have any suitable devices for connection.

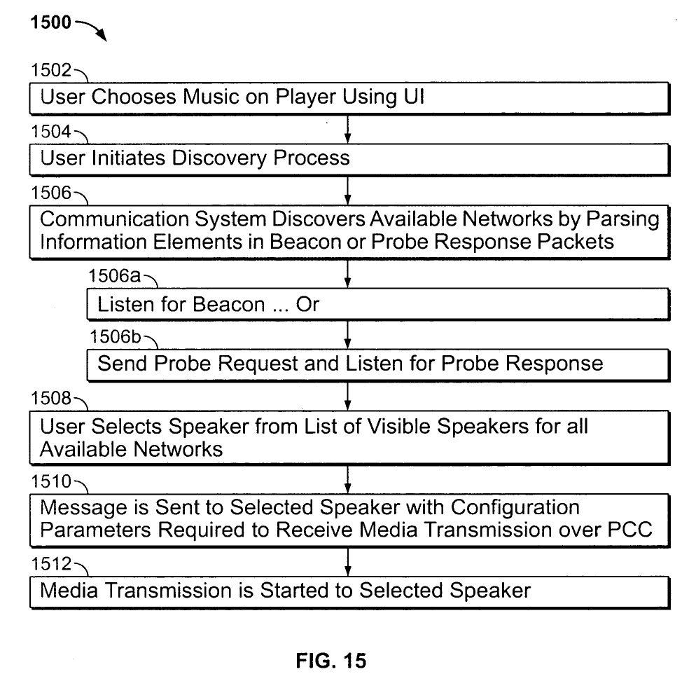

FIG. 15 is a process flow diagram illustrating a process 1500 in accordance with an embodiment of the present invention in which a user interacts with a network using beacon, probe request and probe response packets, such as those available under the IEEE 802.11 standard, to discover and connect to remote speakers.

At block 1502 of process 1500 the user chooses or selects music or content to be played on a player using a user interface (UI). At block 1504 the user initiates a discovery process. At block 1506 the communications system discovers available networks by parsing information elements in beacon OR probe response packets. In block 1506a the beacon is listened for and in block 1506b, an alternative to 1506a, a probe request is transmitted and the probe response is listened for. At block 1508 the user selects a speaker or set of speakers from a list of visible speakers (those apparent to the communications system) from all available networks. At block 1510 a message is sent to selected speaker(s) with configuration parameters required to receive media transmission over the PCC. At block 1512 the media transmission is started to the selected speaker(s).

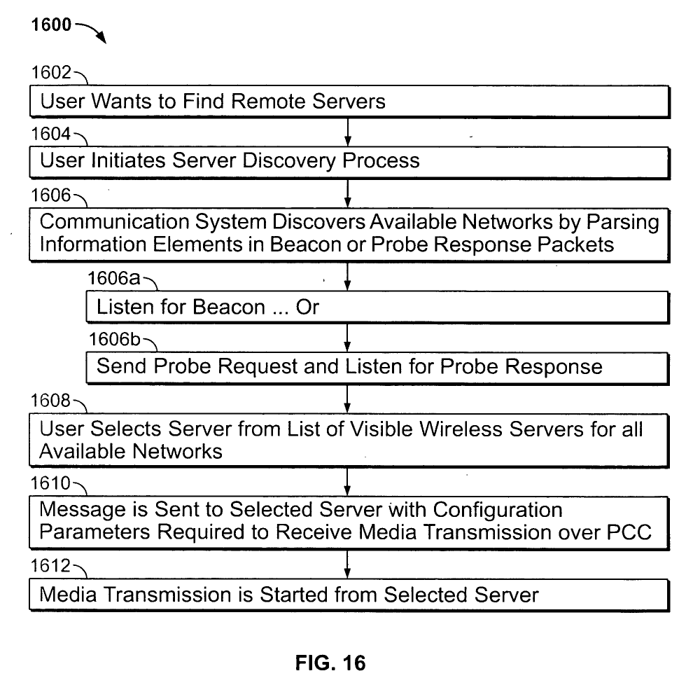

FIG. 16 is a process flow diagram illustrating a process 1600 in accordance with an embodiment of the present invention in which a user interacts with a network using beacon, probe request and probe response packets, such as those available under the IEEE 802.11 standard, to discover and connect to remote servers.

At block 1602 of process 1600 the user chooses or selects a remote server to provide content. Selection is performed using a user interface (UI). At block 1604 the user initiates a server discovery process. At block 1606 the communications system discovers available networks by parsing information elements in beacon OR probe response packets. In block 1606a the beacon is listened for and in block 1606b, an alternative to 1606a, a probe request is transmitted and the probe response is listened for. At block 1608 the user selects a server from a list of visible servers (those apparent to the communications system) from all available networks. At block 1610 a message is sent to the selected server with configuration parameters required to transmit media transmission over the PCC. At block 1612 the media transmission is started from the selected server.

The methods illustrated in FIGS. 15 and 16 use 802.11 Beacon, Probe Request and Probe Response packets, which are network packets that are broadcast by a device to advertise the existence of its network connection, and which have a provision for adding additional information in the form of 802.11 Information Elements. These packets are available prior to association, so step 704c (704c1 through 704c4) of FIG. 7 is not required. This results in quicker discovery and no interaction prior to choosing from the list of available devices. In these examples there are many ways a user can select from the list of available devices, including but not limited to selecting from the complete list of discovered devices using a GUI, or by selecting from available devices one by one as they are discovered using a simple selection mechanism such as a single ‘scan’ button. While these examples use 802.11 as the PCC, this technique is more generally applicable for any PCC by using broadcast information that is available before connecting over the PCC.

Identifying Networked Components with Pictures

The penultimate step in FIGS. 7, 15 and 16 is that the user must select from a list of available devices to choose a particular device for connection. For this, a Graphical User Interface (GUI) may be used where each device is uniquely identified in a list. This involves a configuration step when adding a device to a network. Such an identifier should portray the physical context of the device. For example, a useful text description might be “Kitchen Speakers”; but to create the text string, some sort of text input device must be provided which can be cumbersome to integrate into and use in small devices. A solution to this identification step is to use a photograph of the device, a photograph of the physical context or a photograph or a merged image of the device in context.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for rendering content on a selected renderer, comprising:
using a first wireless communication system to communicate between a controller and a selected renderer an instruction to utilize the renderer for rendering the content, the first wireless communication system covering a first volume of space;
establishing a communications link between a content server serving the content and the renderer, the communication links configured for downloading the content to the renderer;
communicating from the controller to the content server serving the content an identification of content to be rendered;
downloading the content over the communications link from the content server to the renderer in response to said communicating; and
initiating rendering of the content at the renderer.

2. The method of claim 1, wherein:
the communications link between the content server and the renderer is established over a second wireless communication system, wherein the second wireless communication system covers a second volume of space larger than said first volume of space.

3. The method of claim 2, wherein:
the renderer includes an audio renderer.

4. The method of claim 2, wherein:
the renderer includes a visual renderer.

5. The method of claim 2, wherein:
the content is downloaded in the form of an encrypted stream of digital data.

6. The method of claim 1, wherein:
said using includes
pointing an emitter of the controller at a receiver of the renderer; and
emitting a signal over the first wireless communications system from the emitter to the receiver.

7. The method of claim 2, wherein:
said using includes
communicating authentication information from the controller to the renderer, the authentication information configured to authenticate the controller.

8. The method of claim 2, wherein:
said using includes
communicating configuration information from the controller to the renderer, the configuration information arranged to configure the communications link.

9. The method of claim 7, wherein:
said downloading includes
determining that the controller is authenticated before downloading content from the content server to the renderer.

10. A method for communicating between a first device and a second device, the first device including a controller and the second device including a content server, the method comprising:
communicating wirelessly between from the controller to the content server an identification of content to be communicated;
selecting a direction for content communication, a first direction being from the content server to a renderer and a second direction being from a local content server associated with the controller to a renderer or the content server;
establishing a communications link for the selected direction of communication; and
using a wireless communication system to communicate the content over the established communications link.

11. The method of claim 10, wherein:
the selecting is performed with a multi-state control disposed at the controller, a first state of the multi-state control corresponding to the first direction and a second state of the multi-state control corresponding to the second direction.

12. A system for rendering content on a selected renderer, comprising:
means for using a first wireless communication system to communicate between a controller and a selected renderer an instruction to utilize the renderer for rendering the content, the first wireless communication system covering a first volume of space;
means for establishing a communications link between a content server serving the content and the renderer, the communication links configured for downloading the content to the renderer;
means for communicating from the controller to the content server serving the content an identification of content to be rendered;
means for downloading the content over the communications link from the content server to the renderer in response to said communicating; and
means for initiating rendering of the content at the renderer.

13. The method of claim 12, wherein:
the communications link between the content server and the renderer is established over a second wireless communication system, wherein the second wireless communication system covers a second volume of space larger than said first volume of space.

14. The method of claim 13, wherein:
the renderer includes an audio renderer.

15. The method of claim 13, wherein:
the renderer includes a visual renderer.

16. The method of claim 13, wherein:
the content is downloaded in the form of an encrypted stream of digital data.

17. The method of claim 12, wherein:
said means for using includes
means for pointing an emitter of the controller at a receiver of the renderer; and
means for emitting a signal over the first wireless communications system from the emitter to the receiver.

18. The method of claim 13, wherein:
said means for using includes
means for communicating authentication information from the controller to the renderer, the authentication information configured to authenticate the controller.

19. The method of claim 13, wherein:
said means for using includes
means for communicating configuration information from the controller to the renderer, the configuration information arranged to configure the communications link.

20. The method of claim 18, wherein:
said means for downloading includes
means for determining that the controller is authenticated before downloading content from the content server to the renderer.

21. A system for communicating between a first device and a second device, the first device including a controller and the second device including a content server, the system comprising:
means for communicating wirelessly between from the controller to the content server an identification of content to be communicated;
means for selecting a direction for content communication, a first direction being from the content server to a renderer and a second direction being from a local content server associated with the controller to a renderer or the content server;
means for establishing a communications link for the selected direction of communication; and
means for using a wireless communication system to communicate the content over the established communications link.

22. The method of claim 21, wherein:
said means for selecting includes a multi-state control disposed at the controller, a first state of the multi-state control corresponding to the first direction and a second state of the multi-state control corresponding to the second direction.

23. A controller for controlling the rendering of content in a system, the controller comprising:
a first relatively non-directional wireless communications system for communicating with renderers to obtain a list of available renderers;
a user interface configured to enable a user to select one or more renderers for rendering content; and
a second highly directional wireless communication system configured to communicate a selection of a renderer and set up a communications link between a content server and the selected renderer.

24. The controller of claim 23, wherein:
the controller includes a content server for serving content and the user interface includes controls for selecting the content to be rendered on the selected renderer(s).

25. The controller of claim 23, wherein:
the first and second wireless communications systems operate on different electromagnetic radiation frequencies.

26. The controller of claim 25, wherein the first wireless communications system frequency is less than the second wireless communications system frequency.

27. The controller of claim 23, wherein:
the controller is configured as a sleeve device adapted for coupling to another device; and
the controller, when so coupled, includes a content server for serving content and the user interface includes controls for selecting the content to be rendered on the selected renderer(s).

28. The controller of claim 27, wherein:
the first and second wireless communications systems operate on different electromagnetic radiation frequencies.

29. The controller of claim 28, wherein the first wireless communications system frequency is less than the second wireless communications system frequency.

30. A program storage device readable by a machine, tangibly embodying a program of instructions executable by the machine to perform a method for rendering content on a selected renderer, the method including:
using a first wireless communication system to communicate between a controller and a selected renderer an instruction to utilize the renderer for rendering the content, the first wireless communication system covering a first volume of space;
establishing a communications link between a content server serving the content and the renderer, the communication links configured for downloading the content to the renderer;
communicating from the controller to the content server serving the content an identification of content to be rendered;
downloading the content over the communications link from the content server to the renderer in response to said communicating; and
initiating rendering of the content at the renderer.

31. A method for rendering content, comprising:
communicating using a first highly directional wireless communications system between a portable pointable controller and a renderer; and
configuring a communications link between the renderer and a content server, the communications link configured to operate over a second less directional wireless communications system using information provided in said communicating.

32. The method of claim 31, wherein the first wireless communications system and the second wireless communications system operate on different electromagnetic radiation frequencies.

33. The method of claim 31, wherein the controller includes the content server.

34. The method of claim 31, wherein the controller is coupled to a music player device.

35. The method of claim 31, further comprising:
selecting a renderer with said communicating.

36. The method of claim 35, further comprising:
transmitting content from the content server to the renderer over the communications link.

37. The method of claim 31, wherein:
said configuring the communications link includes selecting a renderer and transmitting security, configuration and authentication information.

38. The method of claim 35, wherein:
said selecting a renderer includes pointing the controller at a renderer to be selected and activating a control of a user interface of the controller, and, responsive thereto,
transmitting a renderer selection signal over the first wireless communications system.

39. The method of claim 35, wherein:
said selecting a renderer includes displaying a list of available renderers on a display and using a control of a user interface of the controller to select at least one of the available renderers.

40. The method of claim 39, wherein:
the list is built by the controller in response to pre-programrned instructions.

41. The method of claim 39, wherein:
the list is built by the controller in response to user-programmed instructions.

42. The method of claim 39, wherein:
the list is built by the controller in response to signals received by the controller from available renderers over the first or second communications system.

43. An apparatus for rendering content, comprising:
means for communicating using a first highly directional wireless communications system between a portable pointable controller and a renderer; and
means for configuring a communications link between the renderer and a content server, the communications link configured to operate over a second less directional wireless communications system using information provided in said communicating.

44. The apparatus of claim 43, wherein the first wireless communications system and the second wireless communications system operate on different electromagnetic radiation frequencies.

45. The apparatus of claim 43, wherein the controller includes the content server.

46. The apparatus of claim 43, wherein the controller is coupled to a music player device.

47. The apparatus of claim 43, further comprising:
means for selecting a renderer with said means for communicating.

48. The apparatus of claim 47, further comprising:
means for transmitting content from the content server to the renderer over the communications link.

49. The apparatus of claim 43, wherein:
said means for configuring the communications link includes means for selecting a renderer and means for transmitting security, configuration and authentication information.

50. The apparatus of claim 47, wherein:
said means for selecting a renderer includes means responsive to pointing the controller at a renderer to be selected and activating a control of a user interface of the controller for transmitting a renderer selection signal over the first wireless communications system.

51. The apparatus of claim 47, wherein:
said means for selecting a renderer includes means for displaying a list of available renderers on a display and control means of a user interface of the controller for selecting at least one of the available renderers.

52. A portable pointable controller, comprising:
a local content server;
a local renderer;
a wireless communications system;
a user interface configured to enable a user to selectively upload content using the wireless communications system from a remote content server for rendering on the local renderer.

53. The controller of claim 52, wherein the user interface is further configured to enable a user to selectively download content using the wireless communications system from the local content server to a remote renderer.

54. A portable pointable controller, comprising:
a local content server;
a local renderer;
a wireless communications system;
a user interface configured to enable a user to selectively upload content using the wireless communications system from a remote content server to the local content server.

55. The controller of claim 52, wherein the user interface is further configured to enable a user to selectively download content using the wireless communications system from the local content server to a remote content server.

56. The controller of claim 53, wherein the user interface includes a directional indication indicating whether an upload or a download is in progress.

57. The controller of claim 55, wherein the user interface includes a directional indication indicating whether an upload or a download is in progress.

58. A method for using a portable pointable device having controller capability, optional content server capability and optional renderer capability built into it for using a first communication system to set up a communications link over a second communications system, the method comprising:
using Beacon Packets transmitted by available renderers and/or content servers over the second communications system to facilitate network association and configuration among controllers, content servers and renderers.

59. A method for using a portable pointable device having controller capability, optional content server capability and optional renderer capability built into it for using a first communication system to set up a communications link over a second communications system, the method comprising:
using Probe Request Packets transmitted by controllers, available renderers and/or content servers over the second communications system to facilitate network association and configuration among controllers, available renderers and content servers; and
using Probe Response Packets transmitted in response to the Probe Request Packets transmitted by the controllers, available renderers and/or content servers in order to facilitate the establishment of wireless connections among controllers, available renderers and content servers.

60. The controller of claim 23, further comprising:
a graphical display device configured to display visually perceivable graphical representations of components available for at least one of content serving and content rendering.

61. The controller of claim 60, further comprising:
a user interface associated with the graphical display and configured to enable a user to select available components displayed on the graphical display for use.

62. The controller of claim 61, wherein the controller automatically assigns and displays graphical representation to particular component.

63. The controller of claim 61, wherein the controller is programmed by a user to assign user-selected and/or user-defined graphical representations for association with particular components.

64. The controller of claim 27, wherein the user interface is configured to use a graphical display of the another device and content selection controls of the another device control the selection of content.

65. The controller of claim 64, wherein the another device is a portable digital music player.

66. A wireless renderer device, comprising:
a first wireless communications system configured to receive a command to use the device for rendering content;
means for configuring the device to receive a stream of content from a selected remote content server;
a second wireless communications system configured to receive the stream of content at the device from the selected remote content server; and
circuitry configured to decode, amplify and render the stream of content.
